(19) United States
(12) Patent Application Publication
(10) Pub. No.: US 2020/0016926 A1
(43) Pub. Date: Jan. 16, 2020

(54) ROTATION INDICATOR DEVICE

(71) Applicant: BUSINESS LINES LIMITED, Cumbria (GB)

(72) Inventor: Michael Marczynski, Kirkby Lonsdale (GB)

(21) Appl. No.: 16/497,591

(22) PCT Filed: Mar. 28, 2018
(86) PCT No.: PCT/GB2018/050808

§ 371 Date: Sep. 25, 2019

(30) Foreign Application Priority Data
Mar. 29, 2017 (GB) 1705049.3

(51) Int. Cl. B60B 3/16; F16B 37/14

(52) U.S. Cl. CPC B60B 3/16; B60B 2360/50; B60B 2900/3316; F16B 37/14

(57) ABSTRACT

There is provided a rotation indicator device for mounting onto a polygonal fastener, such as a wheel nut. The device comprises a body having a bore. A pair of tapered regions, which are formed of a resilient material, extend around a periphery the bore, each of the regions being resiliently deformable to, in use, securely and releasably mount the body onto the polygonal fastener such that a rotation of the device relative to the polygonal fastener is inhibited. The device may be used as a safety device to indicate the rotation, i.e. loosening, of the polygonal fastener.

### TECHNICAL FIELD

The invention relates to a rotation indicator device. The invention particularly, though not necessarily, relates to a rotation indicator device for mounting onto a polygonal fastener, e.g. a wheel nut, or other component having a multi-angular peripheral surface.

### BACKGROUND

Various types of rotation indicator devices are known and such devices are widely used on heavy goods vehicles as a safety device to indicate the occurrence of loosening of individual wheel nuts. Many examples of known devices are described in earlier patent specifications, e.g. GB2458644 describes a rotation indicator device comprising an annular body formed of an elastomeric material. The body has a bore extending therethrough, the bore having an edge margin that is tapered in cross section such that the body is mountable onto a wheel nut in a manner that inhibits a relative rotation of the device and the wheel nut. This is possible because the edge margin is resiliently deformable to effect secure attachment of the device to the wheel nut. Thus, the device only rotates upon rotation of the wheel nut, such as when the wheel nut loosens, thereby indicating the rotation. However, this device has been found to exhibit undesirable deformation when it is used in certain applications.

It is an object of embodiments of the invention to at least mitigate one or more problems of known devices.

### SUMMARY OF THE INVENTION

According to the invention, there is provided a rotation indicator device for mounting onto a polygonal fastener, such as a wheel nut, the device comprising: a body having a bore; and a pair of tapered regions formed of a resilient material extending around a periphery the bore, each of the regions being resiliently deformable to, in use, securely and releasably mount the body onto the polygonal fastener such that a rotation of the device relative to the polygonal fastener is inhibited. This arrangement may inhibit undesirable deformation of the device and/or twisting of the body. Additionally or alternatively, the arrangement may allow for an increase in the magnitude of a gripping force applied by the tapered regions to the wheel nut, without sacrificing the ease of which the device is attached to the wheel nut.

One or both of the pair of tapered regions may extend around the entirety of the periphery the bore. In certain embodiments, the body may be formed of the resilient material. The resilient material may be a synthetic rubber material, e.g. a silicone rubber material. Optionally, the device may be formed as a single piece, e.g. as a single piece of the resilient material.

In certain embodiments, the device may further comprise a pointer coupled or integral to the body, the pointer extending laterally from a side of the body, i.e. extending in the plane of device. The pointer may be triangular.

Optionally, the bore is an annular bore. An annular bore may allow the body to be mounted onto polygonal fasteners having a peripheral surface of different shapes, e.g. hexagonal fasteners and square fasteners.

In certain embodiments, the bore has a nominal diameter of between 31 mm and 32 mm and/or a restricted diameter of between 29 mm and 30 mm, the restricted diameter being provided by the tapered regions. The pair of tapered regions may be axially spaced apart from one another.

### BRIEF DESCRIPTION OF THE DRAWINGS

Embodiments of the invention will now be described by way of example only, with reference to the accompanying figures, in which:

FIG. 1 is a perspective view of a rotation indicator device according to an embodiment of the invention;

FIG. 2 is a cross sectional view of the rotation indicator device of FIG. 1, the cross section taken through the centre of the device;

FIG. 3 is a top view of the rotation indicator device of FIG. 1, showing the device in an non-deformed condition; and

FIG. 4 is a top view of the rotation indicator device of FIG. 1, showing the device in a deformed condition mounted onto a polygonal fastener.

### DETAILED DESCRIPTION

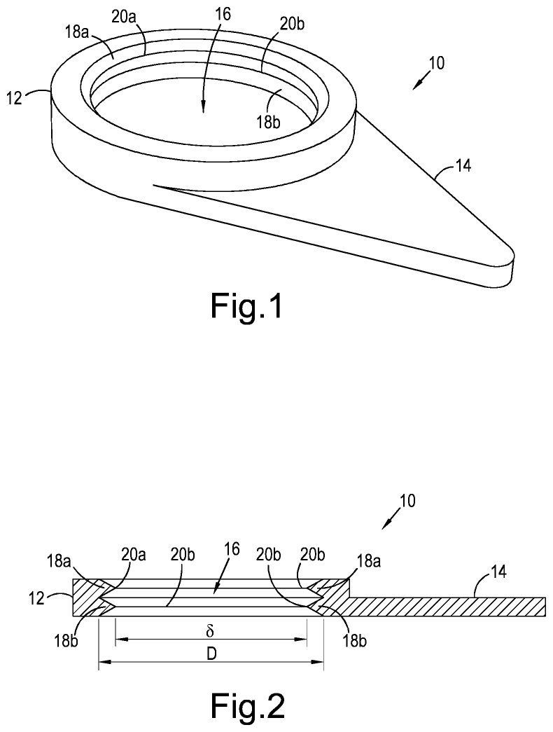

FIG. 1 shows a rotation indicator device 10 according to an embodiment of the invention. The device 10 has particular application as a safety device for releasable attachment to a wheel nut 40 (see FIG. 4) to indicate a rotation thereof. As shown in the accompanying figures, the device 10 may have a substantially annular body 12 and a triangular pointer 14 extending laterally from a side of the body 12. In use, the pointer 14 facilitates indication of the rotation of the wheel nut 40. The body 12 has an annular bore 16 formed to extend axially through its centre, the bore 16 having a nominal diameter D. The bore 16 is configured to allow the body 12 to be mounted onto the wheel nut 40. Specifically, the bore 16 is configured to allow the body 12 to be mounted onto the wheel nut 40 in any angular orientation relative thereto. This is possible owing to a pair of tapered regions 18a, 18b extending circumferentially around a periphery of the bore 16, i.e. extending from the body 12 into the bore 16. Each of the tapered regions 18a, 18b may extend around a portion of the periphery of the bore 16 or may extend around the entirety of the periphery of the bore 16.

FIG. 2 is a cross section of the device 10, showing the profile of the tapered regions 18a, 18b. As can be seen in FIG. 2, each of the tapered regions 18a, 18b gradually varies the diameter of the bore 16 axially, i.e. in the direction that the bore 16 extends through the body 12, to provide a narrowing of the bore 16. Thus, each of the tapered regions 18a, 18b provides a restricted diameter 6 of the bore 16. In the illustrated embodiment, the restricted diameter 6 is defined by respective apexes 20a, 20b of each of the tapered regions 18a, 18b. To this end, the profile of each of the tapered regions 18a, 18b is substantially triangular. As shown in the illustrated embodiment, the restricted diameter 6 may be constant about a circumference bore 16. The restricted diameter 6 is less than the nominal diameter D and the nominal diameter D may be the widest dimension of the bore 16. The nominal diameter D may be defined by parts of the body 12 that delineate, i.e. trace an outline of, the bore 16.

The tapered regions 18a, 18b are formed of a resilient material such they are sufficiently deformable to allow the bore 16 to fit snuggly over a peripheral surface 42 of the wheel nut 40 (see FIG. 4), i.e. each of the tapered regions 18a, 18b is resiliently, i.e. elastically, deformable. The inherent resilience of the tapered regions 18a, 18b causes each to impart a gripping force on the wheel nut 40, when the wheel nut 40 is received in the bore 16, thus securely mounting the body 12 onto the wheel nut 40. The tapered regions 18a, 18b allow for mounting of the body 12 onto the wheel nut 40 such that a rotation of the device 10 relative to the wheel nut 40 is substantially prevented, in either a clockwise or an anti-clockwise direction. Thus, the position of the pointer 14 relative to the wheel nut 40 remains the same as that selected by a user when attaching the device 10 to the wheel nut 40. Thus, the direction in which the pointer 14 points will only change if the wheel nut 40 rotates, as will occur if the wheel nut 40 loosens.

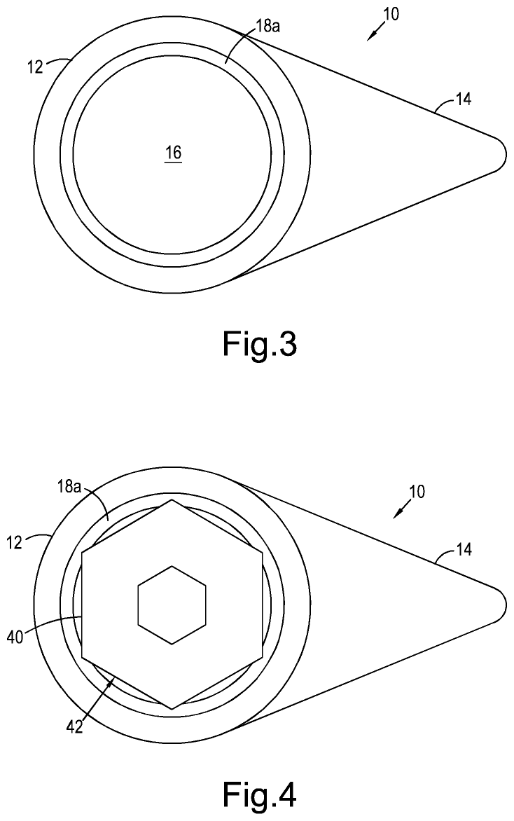

FIGS. 1 to 3 show the device 10 prior to its attachment to the wheel nut 10, i.e. the device 10 is in a non-deformed condition.

FIG. 4 shows the device 10 attached to the wheel nut 40, i.e. the body 12 having been fitted snuggly over the peripheral surface 42 of the wheel nut 40. Thus, FIG. 4 shows the device 10 in a deformed condition. Deformation occurs in the plane of the device 10, i.e. a plane extending across the bore 16. In certain embodiments, deformation of the device 10 may be limited to the tapered regions 18a, 18b. However, in alternative embodiments, deformation of the device 10 may extend to the body 12, e.g. in embodiments where the body 12 is formed of the resilient material. Upon removal of the device 10 from the wheel nut 40, the resilience of the resilient material used to form at least the tapered regions 18a, 18b may allow the device 10 to return to the non-deformed condition, as shown in FIGS. 1 to 3.

Crucially, the pair of tapered regions 18a, 18b enables the body 12 to exert the gripping force against the peripheral surface 42 of the wheel nut 40 at two spaced apart positions. The spacing may nominally correspond to the axial distance between the apexes 20a, 20b. This effect may improve the stability of the device 10 when attached to the wheel nut 40, compared to known arrangements, e.g. the device described in GB2458644. The pair of tapered regions 18a, 18b may ensure that that device 10 does not exhibit undesirable out-of-plane deformations when in use, which has been found to occur in known arrangements. The pair of tapered regions 18a, 18b may reduce the twisting of the body 12 when in use, which has also been found to occur in known arrangements. Out-of-plane deformations and twisting of the body 12 are undesirable, as both increase the likelihood that the device 10 will be accidentally knocked off the wheel nut 40 and/or may reduce the efficacy of the gripping force. The pair of tapered regions 18a, 18b may allow for an increase in the magnitude of the gripping force, without sacrificing the ease of which the device 10 is attached to the wheel nut 40. In alternative embodiments, to increase the spacing between the apexes 20a, 20b, the tapered regions 18a, 18b may be spaced apart, rather than side by side as shown in the accompanying figures.

Of course, the wheel nut 40 may be one of several different wheel nut sizes. The two most commonly used wheel nut sizes used on heavy goods vehicles are 32 mm and 33 mm, measured across the flats. While less common, wheel nut sizes of 30 mm, 31 mm and 34 mm are also used. Careful selection of the nominal diameter D and of the restricted diameter 6, in combination with the choice of material used to form at least the tapered regions 18a, 18b, may allow for the device 10 to be used for a range of wheel nut sizes, e.g. wheel nut sizes ranging from 30 mm to 34 mm. Having a single device which is applicable to multiple wheel nut sizes may reduce manufacturing costs by requiring the use of only a single mould for forming the device 10, or at least a limited number of moulds. To this end, the restricted diameter 6 of the bore 16 may be between 29 mm and 30 mm. In certain embodiments. The nominal diameter D of the bore 16 may be between 31 mm and 32 mm. Of course, each of the restricted diameter 6 and the nominal diameter D may be any suitable size, e.g. the restricted diameter 6 may be between 10 mm and 40 mm and nominal diameter D may be between 12 mm and 42 mm.

The resilient material used to form the tapered regions 18a, 18b may be temperature resistant over a wide range of temperatures, e.g. between −50° C. and 130° C. The resilient material may have a high resistance to oil and/or be impervious to water. A suitable resilient material is silicone rubber. However, the skilled reader will appreciate that other materials would be suitable, e.g. other synthetic rubbers, such as butyl rubber or nitrile rubber. Indeed, the skilled reader will be aware of many commercially available materials having suitable characteristics. The device 10 may be formed from a cross-linked elastomer. As shown in the accompanying figures, the device 10 may be formed as a single piece, i.e. the whole of the device 10 may be formed of the resilient material. In certain embodiments, at least a part of the body 12 which defines the bore 16 may be formed of the resilient material. The device 10 may be moulded. The device 10 may be compression moulded.

The skilled reader will also appreciate that the device 10 is not restricted to releasable attachment to the wheel nut 40, e.g. the device 10 may be releasably attachable to a bolt head. Moreover, the bore 16 may be configured to mount the body 12 onto other types of polygonal fastener, e.g. square nuts and square bolt heads, or any other component having a multi-angular peripheral surface. The device 10 may be releasably attachable to any component part of any assembly for rotation indicating purposes. Such component part may be a circular washer.

The invention is not restricted to the details of any foregoing embodiments. Certain embodiments may not comprise the pointer 14, but instead may have one or more arrows or other similar marking indicia upon a surface of the device 10, the one or more arrows or other similar marking indicia and being capable of indicating rotation of the device 10. In certain embodiments, the pointer 14 may not be triangular. Indeed, the pointer 14 may be any suitable shape, e.g. trapezoidal. As shown in the accompanying figures, the pointer 14 may extend axially along at least a portion of the body 12. However, in alternative embodiments, the pointer 14 may extend axially over a thickness of the body, i.e. all of the body 12. If extending axially over only a portion of the body 12, the pointer 14 may be closer to one side of the body 12 than to another side of the body 12 or may be equispaced between each of the two sides. Attachment or connection of the pointer 14 to the body 12 may be discontinuous. In certain embodiments, the device 10 may, additionally or alternatively, have a projecting tab or the like which serves to indicate that the wheel nut 40 requires attention, e.g. tightening or replacing, during vehicle servicing.

The body 12 does not have to be annular. In certain embodiments, the body 12 may be any suitable shape, e.g. square. Similarly, the bore 16 does not need to be annular. The bore 16 may be any suitable shape for mounting the body 12 to the wheel nut 40, e.g. hexagonal. Thus, as the skilled reader will appreciate, while the above refers to the nominal diameter D and the restricted diameter 6 of the bore 16, the bore 16 may alternatively have a nominal width and a restricted width. Moreover, the shape of the body 12 does not need to correspond to the shape of the bore 16.

The profile of the tapered regions 18a, 18b does not need to be symmetrical in the manner shown in the accompanying figures. One or both of the tapered regions 18a, 18b may have an asymmetrical profile that has a slope at a greater angle at one side of the respective apex 20a, 20b compared to that at the opposing side. Moreover, while the profile of each of tapered regions 18a, 18b described with reference to the accompanying figures is triangular, the profile of one or both of the tapered regions 18a, 18b may alternatively be any suitable shape, e.g. trapezoidal, semi-circular. One or both of the apexes 20a, 20b may be rounded. Certain embodiments may have only a pair tapered regions 18a, 18b. However, alternative embodiments may have any suitable number of tapered regions 18a, 18b greater than one.

The invention extends to any novel one, or any novel combination, of the features disclosed herein (including those of the accompanying claims and drawings). The claims should not be construed to cover merely the foregoing embodiments, but also any embodiments which fall within the scope of the claims.

All of the features disclosed herein (including those of the accompanying claims and drawings) may be combined in any combination, except combinations where at least some of such features are mutually exclusive. Moreover, each feature disclosed herein (including those of the accompanying claims and drawings) may be replaced by alternative features serving the same, equivalent or similar purpose, unless expressly stated otherwise. Thus, unless expressly stated otherwise, each feature disclosed is one example only of a generic series of equivalent or similar features.

1. A rotation indicator device for mounting onto a polygonal fastener, such as a wheel nut, the device comprising:
a body having a bore; and
a pair of tapered regions formed of a resilient material extending around a periphery the bore, each of the regions being resiliently deformable to, in use, securely and releasably mount the body onto the polygonal fastener such that a rotation of the device relative to the polygonal fastener is inhibited.

2. A rotation indicator device according to claim 1, wherein one or both of the pair of tapered regions extends around the entirety of the periphery the bore.

3. A rotation indicator device according to claim 1, wherein the body is formed of the resilient material.

4. A rotation indicator device according to claim 1, wherein the resilient material is a synthetic rubber material, such as a silicone rubber material.

5. A rotation indicator device according to claim 1, wherein the device is formed as a single piece.

6. A rotation indicator device according to claim 1, further comprising a pointer coupled or integral to the body, the pointer extending laterally from a side of the body.

7. A rotation indicator device according to claim 1, wherein the bore is an annular bore.

8. A rotation indicator device according to claim 1, wherein the bore has a nominal diameter of between 31 mm and 32 mm and/or a restricted diameter of between 29 mm and 30 mm, the restricted diameter being provided by the tapered regions.

9. A rotation indicator device according to claim 1, wherein the pair of tapered regions are axially spaced apart from one another.
